(19) United States
(12) Patent Application Publication
(10) Pub. No.: US 2019/0174057 A1
(43) Pub. Date: Jun. 6, 2019

(54) IMAGE ACQUISITION DEVICE, IMAGE PROCESSING DEVICE, IMAGE PROCESSING METHOD, IMAGE PROCESSING PROGRAM, AND IMAGE ACQUISITION SYSTEM

(71) Applicant: OLYMPUS CORPORATION, Tokyo (JP)

(72) Inventors: Maki MATSUNAGA, Tokyo (JP); Yukihito FURUHASHI, Tokyo (JP)

(73) Assignee: OLYMPUS CORPORATION, Tokyo (JP)

(21) Appl. No.: 16/267,225

(22) Filed: Feb. 4, 2019

Related U.S. Application Data
(63) Continuation of application No. PCT/JP2016/076604, filed on Sep. 9, 2016.

(51) Int. Cl. H04N 5/232

(52) U.S. Cl. CPC H04N 5/23222; H04N 5/232933; H04N 5/23216

(57) ABSTRACT

An image acquisition device includes a computer configured to: acquire image data; store a plurality of parameter sets each constituted of a plurality of parameters including photographing conditions and developing conditions; obtain a change from a reference parameter for one of the parameters relating to the photographing conditions, the change being made by a user at the time of acquisition of the image data; extract the parameter sets remaining after excluding the parameter sets involving the change in the changed parameter in a case where the change in the parameter has been obtained; and develop, using the extracted parameter sets, the acquired image data.

### CROSS-REFERENCE TO RELATED APPLICATIONS

This is a continuation of International Application PCT/JP2016/076604 which is hereby incorporated by reference herein in its entirety.

### TECHNICAL FIELD

The present invention relates to image acquisition devices, image processing devices, image processing methods, image processing programs, and image acquisition systems.

### BACKGROUND ART

There is a known type of camera with which, when photographing conditions have been specified by a user, only settings including the specified photographing conditions are extracted and presented to the user (e.g., see Patent Literature 1).

### CITATION LIST

### Patent Literature

### {PTL 1}

Publication of Japanese Patent No. 4492345

### SUMMARY OF INVENTION

An aspect of the present invention is an image acquisition device including a computer configured to: acquire image data; store a plurality of parameter sets each constituted of a plurality of parameters including photographing conditions and developing conditions; obtain a change from a reference parameter for one of the parameters relating to the photographing conditions, the change being made by a user at the time of acquisition of the image data; extract the parameter sets remaining after excluding the parameter sets involving the change in the changed parameter in a case where the change in the parameter has been obtained; and develop, using the extracted parameter sets, the acquired image data.

Another aspect of the present invention is an image processing device including a computer configured to: store a plurality of parameter sets each constituted of a plurality of parameters including photographing conditions and developing conditions; obtain a change, made by a user, from a reference parameter for one of the parameters; extract the parameter sets remaining after excluding the parameter sets involving the change in the changed parameter in a case where the change in the parameter has been obtained; and develop image data using the extracted parameter sets.

Another aspect of the present invention is an image processing method including: obtaining a change, made by a user, from a reference parameter for one of a plurality of parameters; extracting, in a case where the change in the parameter has been obtained, parameter sets remaining after excluding the parameter sets involving the change in the changed parameter from among a plurality of stored parameter sets each constituted of the plurality of parameters including photographing conditions and developing conditions; and developing image data using the extracted parameter sets.

Another aspect of the present invention is a non-transitory computer-readable medium having an image processing program stored therein, the image processing program causing a computer to execute functions of: obtaining a change, made by a user, from a reference parameter for one of a plurality of parameters; extracting, in a case where the change in the parameter has been obtained, parameter sets remaining after excluding the parameter sets involving the change in the changed parameter from among a plurality of stored parameter sets each constituted of the plurality of parameters including photographing conditions and developing conditions; and developing image data using the extracted parameter sets.

Another aspect of the present invention is an image acquisition system including: an imaging device that acquires image data, that stores the acquired image data, and that develops the stored image data; and an image processing device configured to carry out communications with the imaging device. The image processing device includes a computer configured to: store a plurality of parameter sets each constituted of a plurality of parameters including photographing conditions and developing conditions; obtain a change from a reference parameter for one of the parameters relating to the photographing conditions, the change being made by a user at the time of acquisition of the image data by the imaging device; and extract the parameter sets remaining after excluding the parameter sets involving the change in the changed parameter in a case where the change in the parameter has been obtained. The imaging device develops the acquired image data using the parameter sets extracted by the image processing device.

Another aspect of the present invention is an image processing device configured to carry out communications with an imaging device that acquires image data, that stores the acquired image data, and that develops the stored image data, the image processing device including a computer configured to: store a plurality of parameter sets each constituted of a plurality of parameters including photographing conditions and developing conditions; obtain a change from a reference parameter for one of the parameters relating to the photographing conditions, the change being made by a user at the time of acquisition of the image data by the imaging device; and extract the parameter sets remaining after excluding the parameter sets involving the change in the changed parameter in a case where the change in the parameter has been obtained. The extracted parameter sets are used for development of the image data acquired by the imaging device.

Another aspect of the present invention is an image acquisition system including: an imaging device that acquires image data, that stores the acquired image data, and that develops the stored image data; a setting storage device that stores a plurality of parameter sets each constituted of a plurality of parameters including photographing conditions and developing conditions; and an image processing device configured to carry out communications with the imaging device and the setting storage device. The image processing device includes a computer configured to: obtain a change from a reference parameter for one of the parameters relating to the photographing conditions, the change being made by a user at the time of acquisition of the image data by the imaging device; and extract the parameter sets remaining after excluding the parameter sets involving the change in the changed parameter in a case where the change in the parameter has been obtained. The imaging device develops the acquired image data using the parameter sets extracted by the image processing device.

Another aspect of the present invention is an image processing device configured to carry out communications with: an imaging device that acquires image data, that stores the acquired image data, and that develops the stored image data; and a setting storage device that stores a plurality of parameter sets each constituted of a plurality of parameters including photographing conditions and developing conditions, the image processing device including a computer configured to: obtain a change from a reference parameter for one of the parameters relating to the photographing conditions, the change being made by a user at the time of acquisition of the image data by the imaging device; and extract the parameter sets remaining after excluding the parameter sets involving the change in the changed parameter in a case where the change in the parameter has been obtained. The extracted parameter sets are used for development of the image data acquired by the imaging device.

Another aspect of the present invention is an image acquisition system, wherein an imaging device that acquires image data and that stores the acquired image data, a developing device that develops the image data, and an image processing device are configured to carry out communications with one another. The image processing device includes a computer configured to: store a plurality of parameter sets each constituted of a plurality of parameters including photographing conditions and developing conditions; obtain a change from a reference parameter for one of the parameters relating to the photographing conditions, the change being made by a user at the time of acquisition of the image data by the imaging device; and extract the parameter sets remaining after excluding the parameter sets involving the change in the changed parameter in a case where the change in the parameter has been obtained. The developing device develops, using the parameter sets extracted by the image processing device, the image data acquired by the imaging device.

Another aspect of the present invention is an image processing device configured to carry out communications with: an imaging device that acquires image data and that stores the acquired image data; and a developing device that develops the image data, the image processing device including a computer configured to: store a plurality of parameter sets each constituted of a plurality of parameters including photographing conditions and developing conditions; obtain a change from a reference parameter for one of the parameters relating to the photographing conditions, the change being made by a user at the time of acquisition of the image data by the imaging device; and extract the parameter sets remaining after excluding the parameter sets involving the change in the changed parameter in a case where the change in the parameter has been obtained. The extracted parameter sets are used for development of the image data acquired by the imaging device.

### BRIEF DESCRIPTION OF DRAWINGS

FIG. 1 is a diagram showing the overall configuration of an image acquisition device according to an embodiment of the present invention.

FIG. 2 is a diagram showing an example of parameter sets stored in a setting storage unit of the image acquisition device in FIG. 1.

FIG. 3 shows an example display presenting the parameter sets extracted in the image acquisition device in FIG. 1.

FIG. 4 shows an example display in which one of the parameter sets has been selected in the example display in FIG. 3.

FIG. 5 shows an example in which the parameter sets in FIG. 2 are stored in a hierarchical structure.

FIG. 6 shows another example in which the parameter sets in FIG. 2 are stored in a hierarchical structure.

FIG. 7 shows another example display presenting the parameter sets extracted in the image acquisition device in FIG. 1.

FIG. 8 is a diagram showing the overall configuration of a modification of the image acquisition device in FIG. 1.

FIG. 9 is a diagram showing the overall configuration of an image acquisition system according to an embodiment of the present invention.

FIG. 10 is a flowchart for explaining an image processing method executed by an image processing device included in the image acquisition system in FIG. 9.

FIG. 11 is a diagram showing the overall configuration of a modification of the image processing device included in the image acquisition system in FIG. 9.

FIG. 12 is a diagram showing the overall configuration of a modification of the image acquisition system in FIG. 9.

FIG. 13 is a diagram showing the overall configuration of another modification of the image acquisition system in FIG. 9.

### DESCRIPTION OF EMBODIMENTS

An image acquisition device 1 according to an embodiment of the present invention will be described below with reference to the drawings.

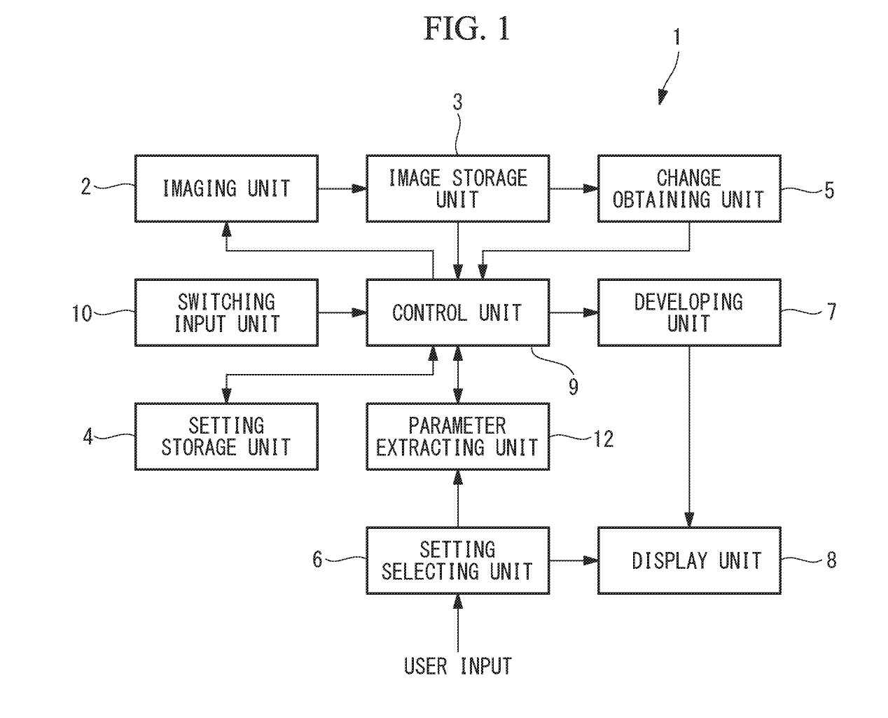

As shown in FIG. 1, the image acquisition device 1 according to this embodiment includes an imaging unit 2, an image storage unit 3, a setting storage unit 4, a change obtaining unit 5, a parameter extracting unit 12, a setting selecting unit 6, a developing unit 7, a display unit 8, and a control unit 9 that controls these units. The imaging unit 2 acquires image data of an object. The image storage unit 3 stores the image data transferred from the imaging unit 2. The setting storage unit 4 stores a plurality of parameter sets each constituted of a combination of a plurality of parameters including photographing conditions and developing conditions. The change obtaining unit 5 obtains a change in one of the parameters relating to the photographing conditions from a reference parameter, the change being made by a user at the time of acquisition of the image data by the imaging unit 2. The parameter extracting unit 12 extracts, in the case where the change obtaining unit 5 has obtained a parameter change, the parameter sets remaining after excluding the parameter sets involving the change in the changed parameter. The setting selecting unit 6 presents the parameter sets extracted by the parameter extracting unit 12 and allows the user to select one therefrom. The developing unit 7 develops the image data acquired by the imaging unit 2 using the parameter sets selected by the user via the setting selecting unit 6. The display unit 8 displays an image. The image acquisition device 1 also includes a switching input unit 10 that allows the user to perform an operation for switching the photographing conditions at the time of photographing.

The imaging unit 2 includes a photographing lens (not shown) that collects light from the object, and an imaging element (not shown), such as a CCD, that photographs the light collected by the photographing lens to acquire image data. The user may perform photography by using auto-setting (reference parameters) without having to operate the switching input unit 10 before photographing or may change one of the photographing conditions by operating the switching input unit 10 before photographing.

Although the change obtaining unit 5 may detect a parameter change made by operating the switching input unit 10, here, the change obtaining unit 5 is configured to detect a parameter change on the basis of a changed parameter stored in association with the acquired image data.

The setting selecting unit 6 is configured not to operate in the case where photography is performed without changing the auto-setting and to operate in the case where it is detected by the change obtaining unit 5 that one of the parameters relating to the photographing conditions has been changed by operating the switching input unit 10.

Furthermore, a parameter change made in a state in which an image is viewed through a live view monitor may be detected, even without photographing an image.

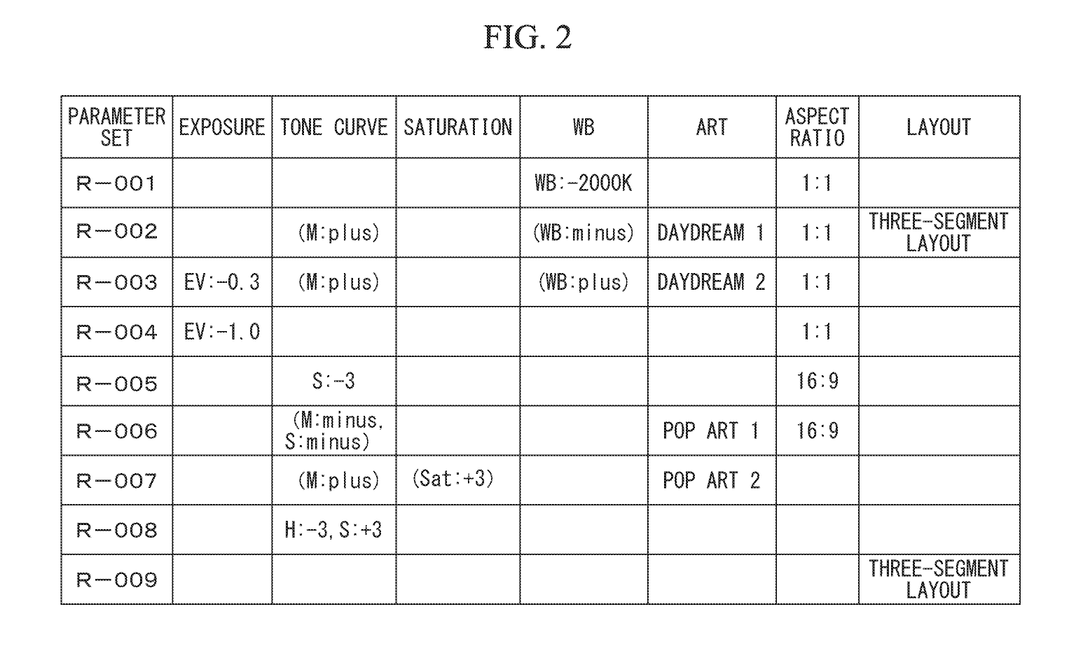

As an example, the following describes a case where a plurality of parameter sets shown in FIG. 2 are stored in the setting storage unit 4. In the example shown in FIG. 2, the leftmost column represents the name of the parameter set, the exposure and the white balance (WB) are included as the parameters relating to the photographing conditions, and the tone curve, the saturation, the art filter (ART), the aspect ratio, and the layout are included as parameters relating to the developing conditions.

In this case, if, for example, the user performs photography after reducing the color temperature, which is the parameter relating to the white balance, by 1500 K, the change obtaining unit 5 detects this change, and the parameter extracting unit 12 operates accordingly.

In this example, the parameter extracting unit 12 extracts parameter sets R-004 to R-009 remaining after excluding, from among the parameter sets stored in the setting storage unit 4, R-001, in which the white balance is changed, and R-002 and R-003, which involve changes in the white balance in the art filters. Then, the setting selecting unit 6 is configured to present R-004 to R-009, which have been extracted by the parameter extracting unit 12.

The setting selecting unit 6 is configured to present the extracted parameter sets on the display unit 8, allowing the user to select one of the parameter sets. For example, the setting selecting unit 6 is implemented in the form of a GUI.

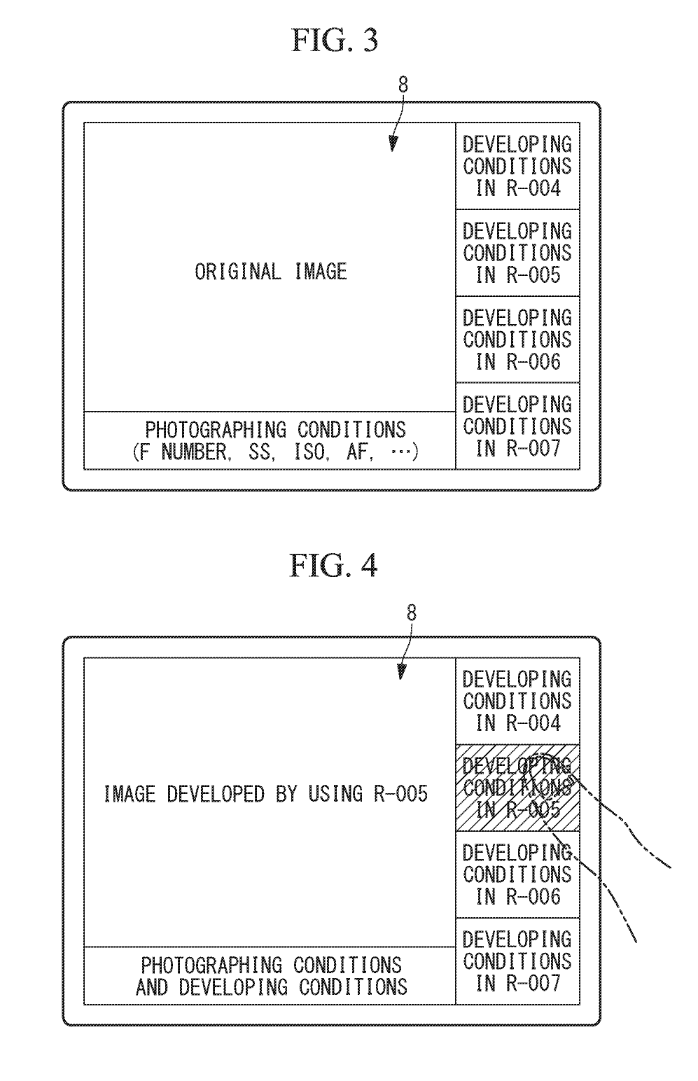

More specifically, in the case where the user changes one of the photographing conditions before performing photography, as shown in FIG. 3, the acquired original image is displayed on the display unit 8, and the developing conditions of the parameter sets extracted by the parameter extracting unit 12 are presented by the setting selecting unit 6 on the display unit 8.

Although the developing conditions of the parameter sets R-004 to R-007 are shown in the example shown in FIG. 3, the other parameter sets R-008 and R-009 can also be displayed by scrolling the screen.

The developing conditions of the parameter sets may be presented by displaying thumbnails showing the effects obtained when the developing conditions are applied to the reduced-size original image.

The user is allowed to select one of the parameter sets presented on the display unit 8. For example, as shown in FIG. 4, when the parameter set R-005 is selected, the developing unit 7 performs development by using the selected parameter set R-005, and the developed image is displayed on the display unit 8 instead of the original image.

With the thus-configured image acquisition device 1 according to this embodiment, in the case where the user changes the photographing conditions at the time of photographing, the parameter sets remaining after excluding the parameter sets involving the change in the photographing conditions are presented. By not changing the parameter changed by the user in respect for the user's intent, it is possible to give the user ideas of visual effects in images obtained when the other parameters are changed in addition to the parameter changed by the user, thus expanding the range of expression by the user, which is advantageous.

More specifically, in the conventional systems, in the case where the user changes the photographing conditions at the time of photographing, only parameter sets including photographing conditions matching the changed photographing conditions are presented. Thus, in the example in FIG. 2, for example, in the case where the user performs photography after reducing the color temperature, which is the parameter relating to the white balance, by 2000 K, only the parameter set R-001 is presented.

Accordingly, the user is not given an opportunity to recognize visual effects that can be added to images by adjusting other developing conditions, such as the tone curve, the art filter, the aspect ratio, and the layout, in addition to the white balance. This results in a failure to expand the range of expression.

In contrast, with the image acquisition device 1 according to this embodiment, the user is given an opportunity to check visual effects in images that are acquired when other developing conditions are added to the change in the photographing conditions made by the user.

In the case where the user wishes to adopt the image displayed on the display unit 8, developed by using the selected parameter set, the user may add and store the parameter set as a favorite so that the user can read out and use the parameter set at a later occasion of photographing.

Note that, in this embodiment, development may be performed without selecting a parameter set, but using all the developing conditions of the extracted parameter sets. In such a case, because the user does not select a parameter set, the setting selecting unit 6 is unnecessary.

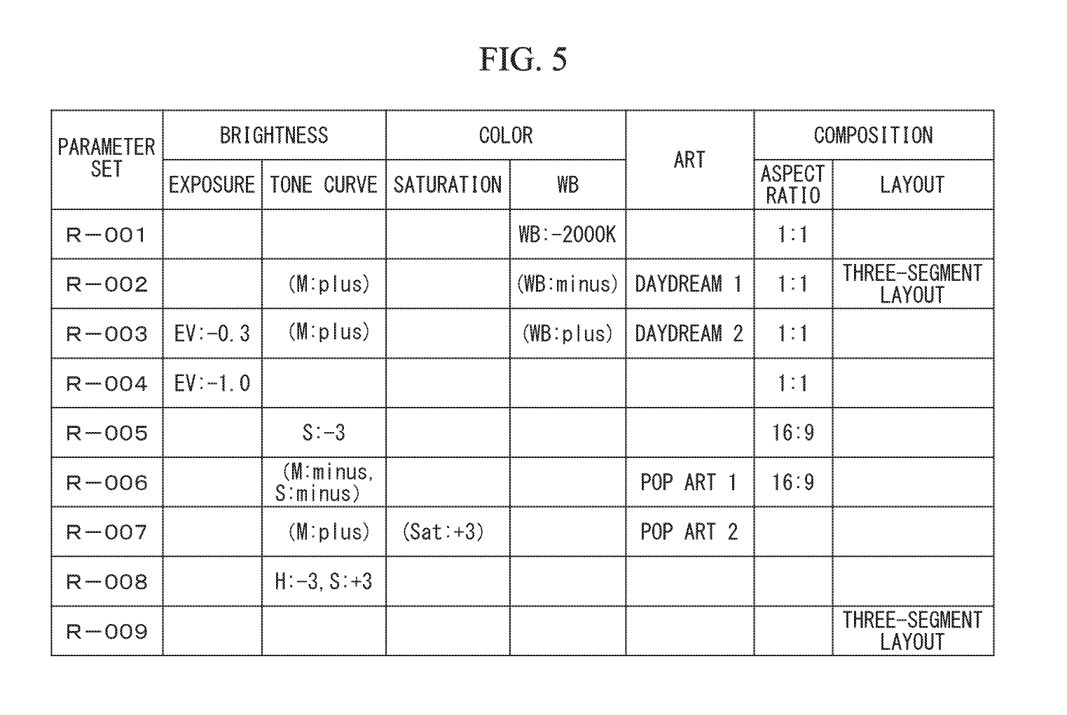

Furthermore, although the system is configured such that, for each of the photographing conditions, the parameter set involving the change in the photographing condition matching the photographing condition changed at the time of photographing is excluded from the parameter sets to be selected, instead, as shown in FIG. 5, the system may be configured such that each of the parameters in the parameter sets stored in the setting storage unit 4 has a hierarchical structure. In the case where a change in one of the parameters is detected, the parameter sets involving any change in the parameters included in the higher level are excluded.

More specifically, in the example shown in FIG. 5, the “tone curve” and the “exposure” may be included in a higher-hierarchy parameter “brightness”, the “saturation” and the “white balance” may be included in a higher-hierarchy parameter “color”, and the “aspect ratio” and the “layout” may be included in a higher level “composition”.

With this configuration, for example, similarly to the above, in the case where the user changes the white balance at the time of photographing, not only the parameter sets R-001 to R-003, which involve a change in the white balance, but also the parameter set R-007, which involve a change in the saturation, are excluded from the selection objects.

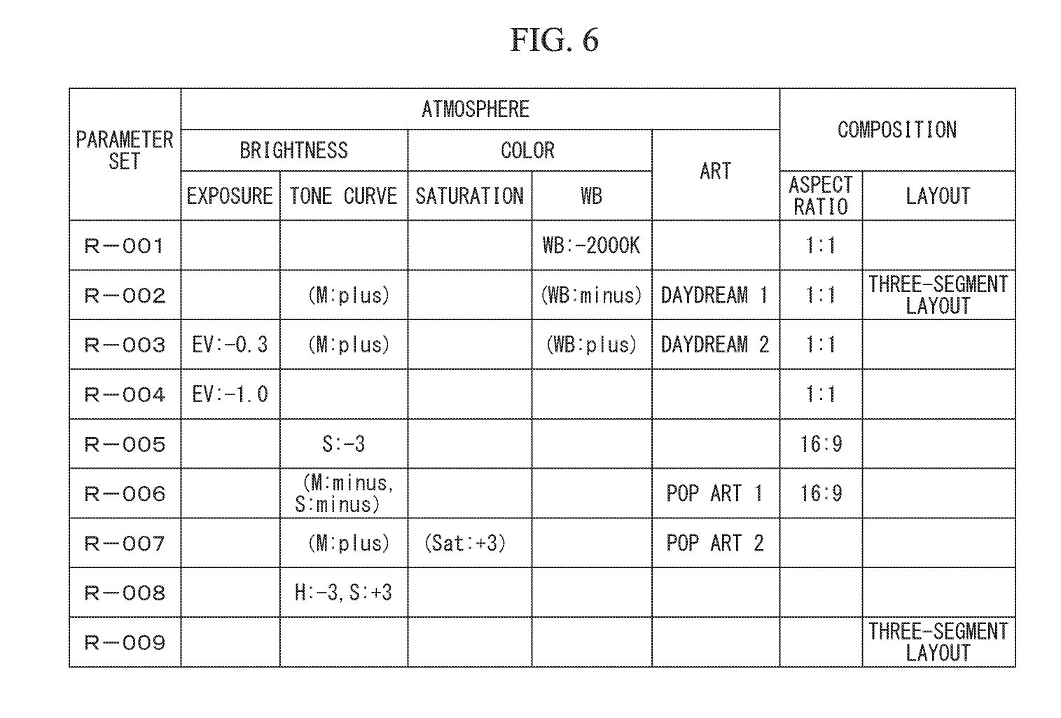

The hierarchical structure does not necessarily have to have a two-level structure as described above, but may be configured to have, for example, a three-level structure, in which “brightness”, “color”, and “ART” are included in a higher level “atmosphere”, as shown in FIG. 6.

Furthermore, the system may be configured such that the user can set to which level in the hierarchical structure the parameter sets are excluded.

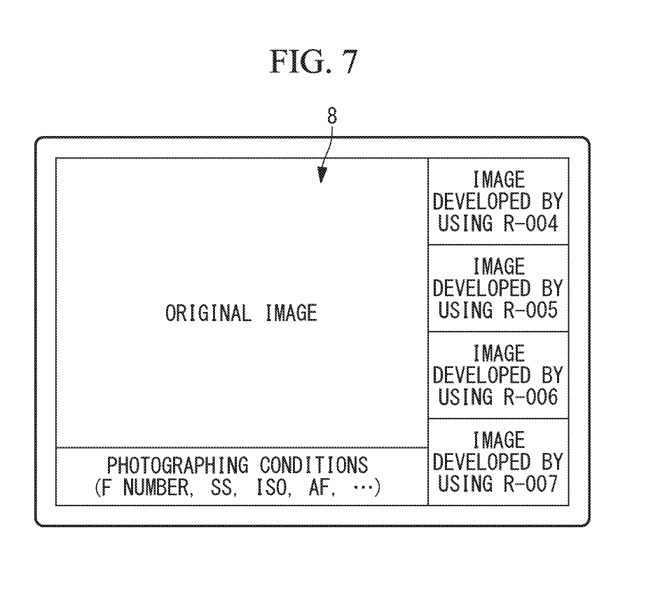

Furthermore, in this embodiment, regarding the parameter sets extracted by the parameter extracting unit 12, the developing conditions themselves included in the parameter sets are displayed on the display unit 8. Alternatively, as shown in FIG. 7, images generated by developing the original image by using the individual parameter sets extracted by the parameter extracting unit 12 may be displayed as images for selection. In this case, the user is prompted to select one of the images presented by the setting selecting unit 6, and the selected image is displayed in enlarged form.

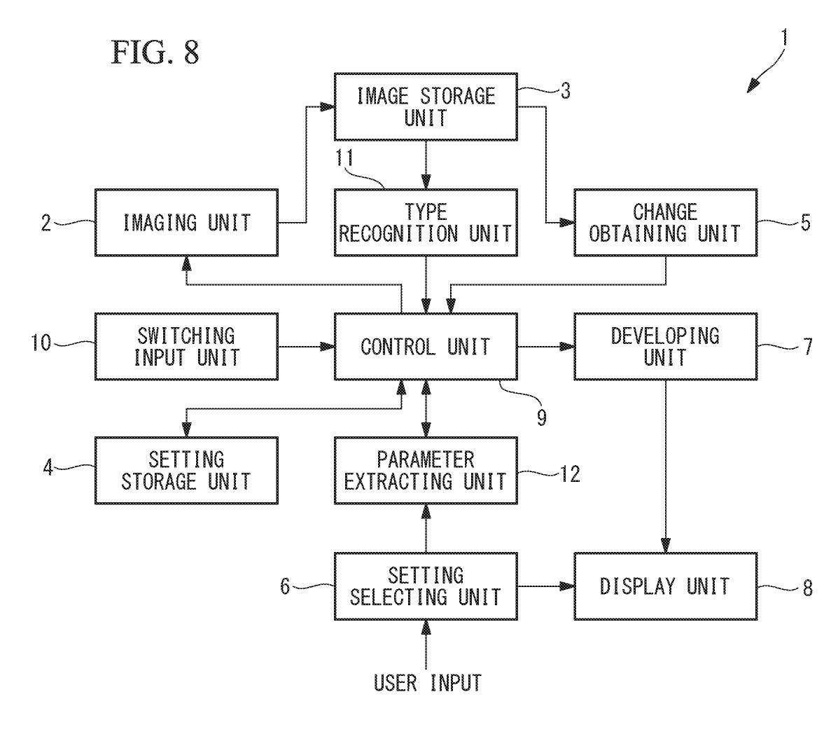

Furthermore, in this embodiment, as shown in FIG. 8, the parameter sets may be stored in the setting storage unit 4 as classified on the basis of object types or scene types. In this case, a type recognition unit 11 that processes the image acquired by the imaging unit 2 to recognize the object type or scene type may be provided, and the parameter extracting unit 12 may extract only the parameter sets belonging to the class matching the recognized type.

Accordingly, in the case where a large number of parameter sets are stored, parameter sets that are presented are narrowed down to parameter sets in accordance with the demand of the user, which facilitates selection.

Furthermore, although all the parameter sets extracted by the parameter extracting unit 12 are presented in this embodiment, the parameter sets may be reduced at random or on the basis of the previous selection history or the previous occurrence frequency before being presented.

Next, an image processing device 30, an image acquisition system 100, and an image processing method according to another embodiment of the present invention will be described below with reference to the drawings.

In the description of this embodiment, parts that are configured the same as those in the image acquisition device 1 according to the embodiment described above will be designated by the same reference signs, and descriptions thereof will be omitted.

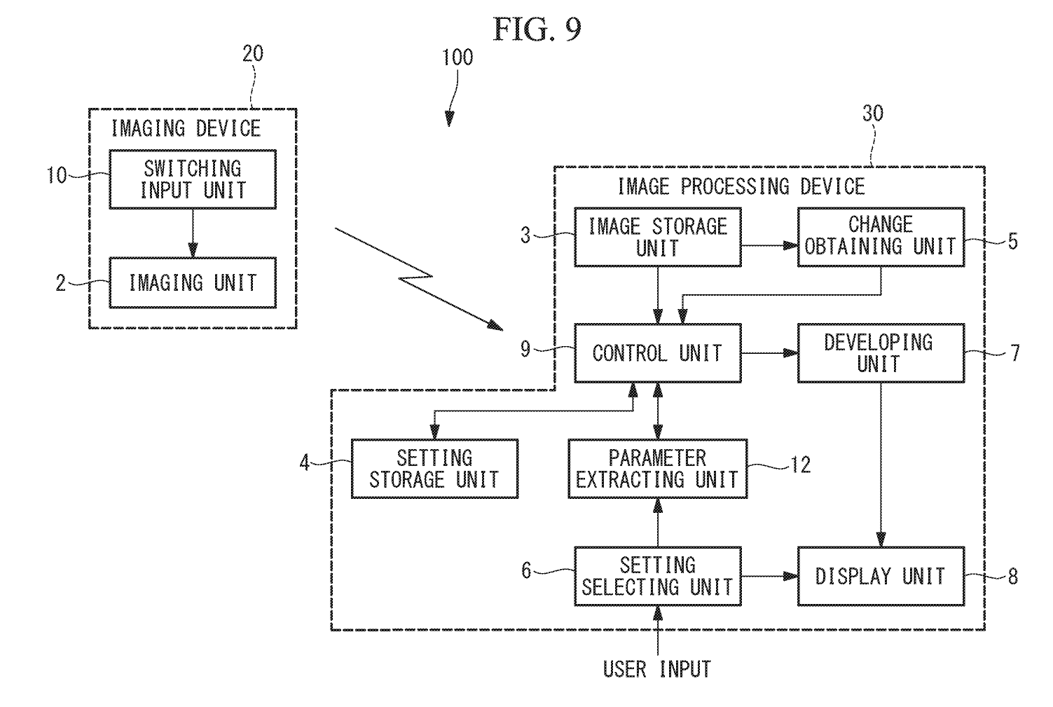

As shown in FIG. 9, the image acquisition system 100 according to this embodiment includes an imaging device 20 and an image processing device 30.

As shown in FIG. 9, the imaging device 20 includes an imaging unit 2 and a switching input unit 10 configured to set photographing conditions.

The image acquisition system 100 is configured such that image data acquired by the imaging device 20 can be input to the image processing device 30 by way of communications or via a storage medium, in association with a photographing-condition change input via the switching input unit 10.

The image processing device 30 includes an image storage unit 3, a setting storage unit 4, a change obtaining unit 5, a parameter extracting unit 12, a setting selecting unit 6, a developing unit 7, a display unit 8, and a control unit 9. The functions of these components are the same as those in the image acquisition device 1 described above.

A digital camera or a smart phone that has a communication function may be used as the imaging device 20, and the present invention may be applied to only the image processing device 30 side.

An image processing method using the thus-configured image processing device 30 according to this embodiment will be described below.

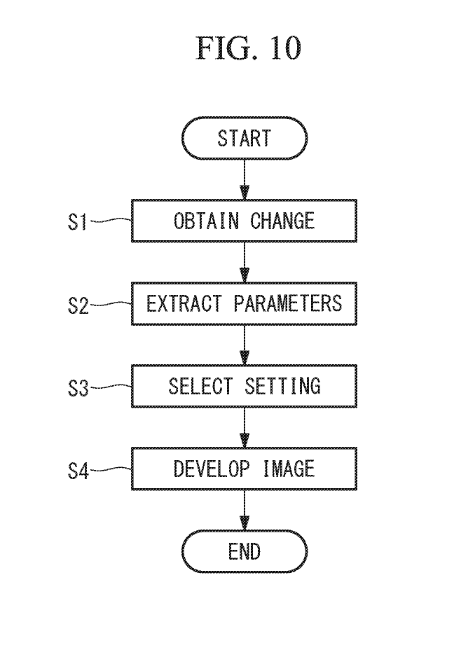

As shown in FIG. 10, the image processing method according to this embodiment includes a change obtaining step S1, a parameter extracting step S2, a setting selecting step S3, and a developing step S4.

In the change obtaining step S1, when image data associated with a change in a photographing condition is input to the image storage unit 3 by way of communications or via a storage medium, the change obtaining unit 5 obtains the change in the photographing condition at the time of photographing, associated with the image data.

In the parameter extracting step S2, the parameter sets involving the change in the parameter made by the user are excluded from the parameter sets stored in the setting storage unit 4, and the remaining parameter sets are extracted. The extracted parameter sets are displayed on the display unit 8 by the setting selecting unit 6.

Then, in the setting selecting step S3, one of the parameter sets extracted in the parameter extracting step S2 is selected by the user. Then, in developing step S4, the image data is developed by using the parameter set selected by the user in the setting selecting step S3.

As described above, also with the image acquisition system 100, the image processing device 30, and the image processing method according to this embodiment, while respecting the intent of a user who has specified a photographing condition, an advantage is afforded in that it is possible to prevent the range of expression from being narrowed.

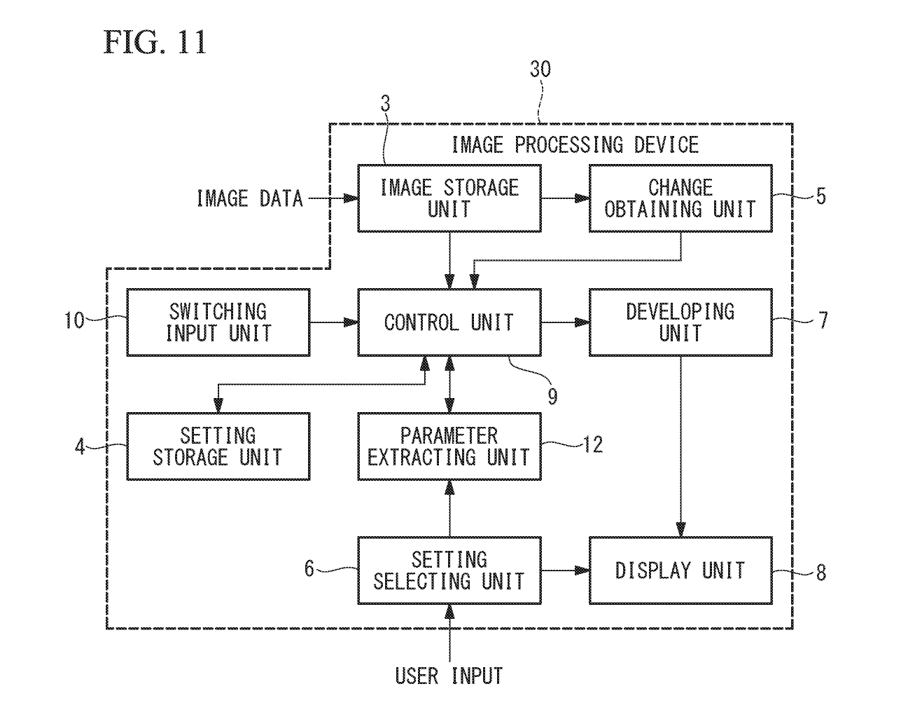

In this embodiment, in the case where the user changes a photographing condition from the auto-setting at the time of photographing by the imaging device 20, the change is detected, and the parameter sets to be presented are then extracted. Alternatively, as shown in FIG. 11, the image processing device 30 may include a switching input unit 10 configured to change the photographing conditions, such as the white balance. In this case, image data acquired with the auto-setting may be received, and parameter sets may then be extracted.

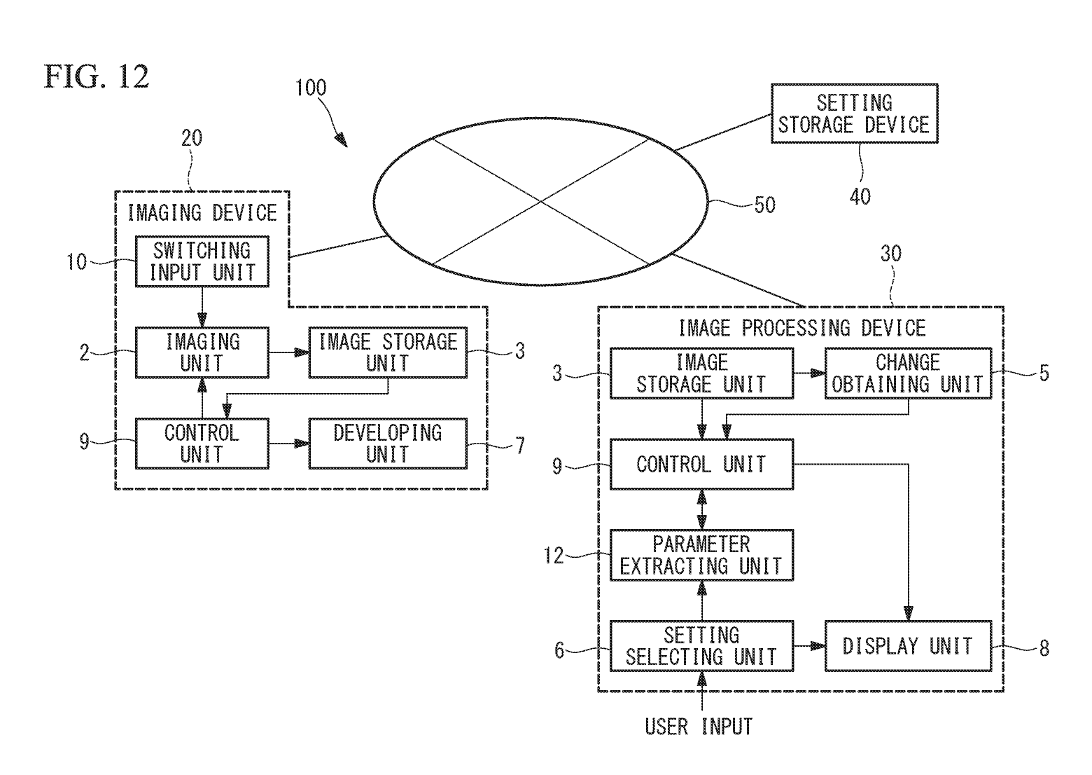

Furthermore, in the embodiment described above, the image processing device 30 includes the setting storage unit 4 that stores parameter sets and also includes the developing unit 7. Alternatively, as shown in FIG. 12, it is possible to adopt an image acquisition system 100 in which the setting storage unit 4 and the developing unit 7 are not provided in the image processing device 30, in which a setting storage device 40 that stores parameter sets is connected to the imaging device 20 and the image processing device 30 via a network 50, and in which the imaging device 20 includes the control unit 9, the image storage unit 3, and the developing unit 7.

In this case, for example, the image processing device 30 is a personal computer, a mobile terminal, or the like. The control units 9 in the imaging device 20 and the image processing device 30 are configured to control the individual components and to send and receive information via the network 50.

Large-size image data acquired at the imaging device 20 by photographing with the photographing conditions changed by the user is stored in the image storage unit 3 without being sent to the image processing device 30, and only information about the photographing conditions changed by the user, or this information together with reduced image data for display, is sent to the image processing device 30 via the network 50.

At the image processing device 30, the parameter sets extracted in the manner described above are presented on the display unit 8. When one of the parameter sets is selected by the user, the selected parameter set is sent to the imaging device 20 via the network 50. Then, the image data stored in the imaging device 20 is developed by using the received parameter set. Then, image data reduced for display is returned to the image processing device 30 and is displayed on the display unit 8.

Accordingly, it is possible to reduce the time needed for communication without having to upload large-size image data acquired by the imaging device 20 to the image processing device 30.

Furthermore, the time for development can be reduced by utilizing hardware that is an essential component of a typical imaging device and that is used solely for development.

Although the setting selecting unit 6 and the display unit 8 are provided on the image processing device 30 side in FIG. 12, the setting selecting unit 6 and the display unit 8 may be provided on the imaging device 20 side and connected to the control unit 9.

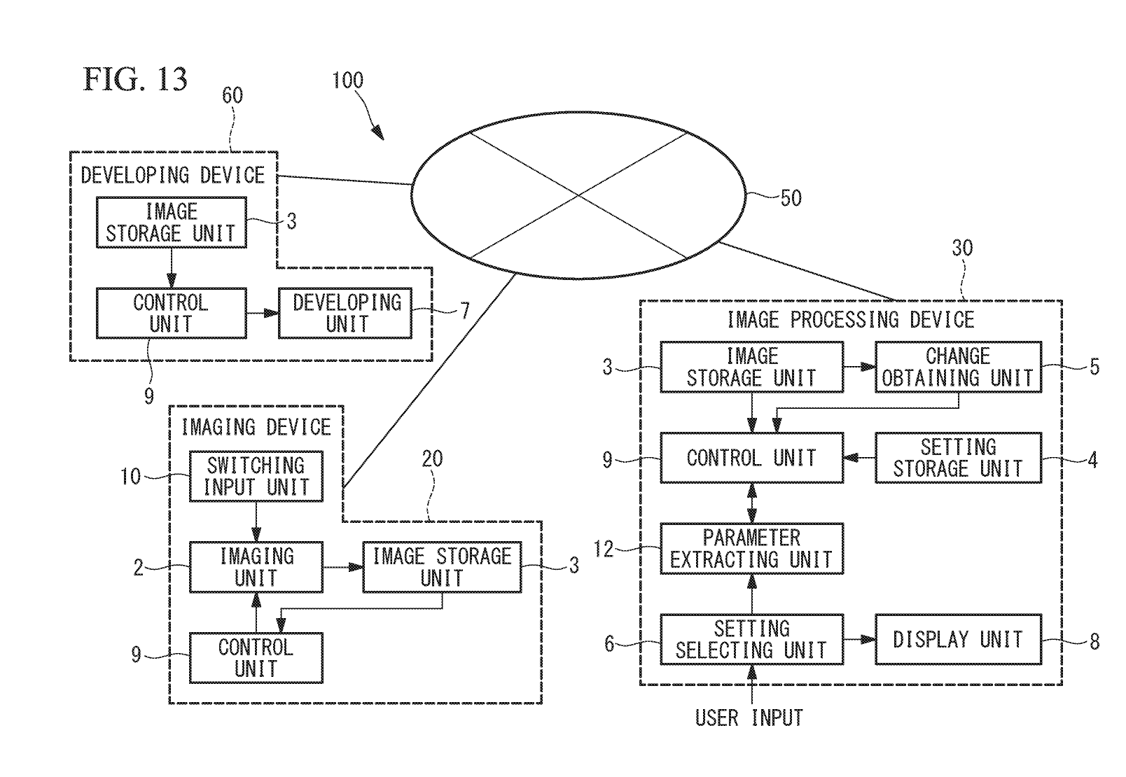

Furthermore, although the developing unit 7, which develops image data, is provided in the image processing device 30 in the above-described embodiment, alternatively, as shown in FIG. 13, it is possible to adopt an image acquisition system 100 in which the developing unit 7 is not provided in the image processing device 30, in which a developing device 60 that develops image data is connected to the imaging device 20 and the image processing device 30 via the network 50, in which the control unit 9, the image storage unit 3, and the developing unit 7 are provided in the developing device 60, and in which the control unit 9 and the image storage unit 3 are provided in the imaging device 20.

In this case, for example, the image processing device 30 is a personal computer, a mobile terminal, or the like. The control units 9 in the developing device 60, the imaging device 20, and the image processing device 30 are configured to control the individual components and to send and receive information via the network 50.

At the image processing device 30, the parameter sets extracted in the manner described above are presented on the display unit 8. When one of the parameter sets is selected by the user, the selected parameter set is sent to the developing device 60 via the network 50. Then, the image data stored in the imaging device 20 is sent to the developing device 60 via the network 50. Then, the image data is developed by using the received parameter set. Then, the image data reduced for display is returned from the developing device 60 to the image processing device 30 via the network 50 and is displayed on the display unit 8.

Furthermore, although the embodiments have been described in the context of configurations in which an image processing method is realized by hardware, the image processing method may be realized by an image processing program that can be executed by a computer. In this case, the computer includes a CPU, a main memory device such as a RAM, and a computer-readable recording medium, and an image processing program for realizing the processing described above is recorded in the recording medium. The CPU reads the image processing program recorded in the recording medium, which makes it possible to realize the same processing as the image processing device 30.

Furthermore, although the setting selecting unit 6 and the display unit 8 are provided on the image processing device 30 side in this embodiment, alternatively, the setting selecting unit 6 and the display unit 8 may be provided on the imaging device 20 side, and the setting selecting unit 6 and the display unit 8 may be connected to the control unit 9.

The above-described embodiment also leads to the following invention.

An aspect of the present invention is an image acquisition device including: an imaging unit that acquires image data; a setting storage unit that stores a plurality of parameter sets each constituted of a plurality of parameters including photographing conditions and developing conditions; a change obtaining unit that obtains a change from a reference parameter for one of the parameters relating to the photographing conditions, the change being made by a user at the time of acquisition of the image data by the imaging unit; a parameter extracting unit that extracts the parameter sets remaining after excluding the parameter sets involving the change in the changed parameter in the case where the change obtaining unit has obtained the change in the parameter; and a developing unit that develops, using the parameter sets extracted by the parameter extracting unit, the image data acquired by the imaging unit.

According to this aspect, if the user changes one of the parameters relating to photographing conditions from the reference parameter in performing photography to acquire image data by using the imaging unit, the change obtaining unit obtains the parameter change made at the time of acquisition of the image data, and the parameter extracting unit extracts, from among the plurality of parameter sets stored in the setting storage unit, only parameter sets that do not involve the obtained change in the parameter. By developing, using the extracted parameter sets, the image data acquired by the imaging unit, it is possible to give the user ideas of visual effects in images obtained when parameters are changed, thus expanding the range of expression.

In the above aspect, the image acquisition device may further include a setting selecting unit that presents the parameter sets extracted by the parameter extracting unit and allows the user to select one therefrom.

With this configuration, when the user selects one of the parameter sets presented by the setting selecting unit, the image data acquired by the imaging unit is developed by using the selected parameter set.

Specifically, by excluding, from the parameter sets to be presented to the user, parameter sets involving the parameter change made by the user, the parameter changed by the user is not changed in respect for the user's intent, and images developed by using parameter sets in which the other parameters are changed are presented. By doing so, it is possible to give the user ideas of visual effects in images obtained when the other parameters are changed in addition to the parameter changed by the user, thus expanding the range of expression by the user.

In the above aspect, the image acquisition device may further include a setting selecting unit that presents images showing the effects obtained when the image data is developed using the parameter sets extracted by the parameter extracting unit and allows the user to select one therefrom.

With this configuration, it is possible to directly check, before selecting, the image data developed using the parameter sets extracted by the parameter extracting unit, making selection by the user easy.

In the above aspect, the parameters stored in the setting storage unit may have a hierarchical structure, and, in the case where the change obtaining unit has obtained a change in one of the parameters, the parameter extracting unit excludes parameter sets involving any change in the parameters included in a higher level than the parameter for which the change has been obtained

With this configuration, one of the parameters included in a higher level than the parameter for which the change has been obtained is a parameter that adds the same type of effect. Hence, by excluding parameter sets involving a change in a parameter included in the higher level, it is possible to present only the parameter sets that respect the intent of the user even more.

In the above aspect, the image acquisition device may further include a type recognition unit that recognizes the type of an object or the type of a scene in the image data. The setting storage unit may store the parameter sets as classified on the basis of the type of the object or the type of the scene. The parameter extracting unit may extract parameter sets to be presented from parameter sets belonging to the class matching the type of the object or the type of the scene recognized by the type recognition unit.

With this configuration, even when there are many parameter sets, it is possible to extract and present only the parameter sets belonging to the class matching the type of the object or the type of the scene in the image data, making selection by the user easy.

Another aspect of the present invention is an image processing device including: a setting storage unit that stores a plurality of parameter sets each constituted of a plurality of parameters including photographing conditions and developing conditions; a change obtaining unit that obtains a change, made by a user, from a reference parameter for one of the parameters; a parameter extracting unit that extracts the parameter sets remaining after excluding the parameter sets involving the change in the changed parameter in the case where the change obtaining unit has obtained the change in the parameter; and a developing unit that develops image data using the parameter sets extracted by the parameter extracting unit.

According to this aspect, the change obtaining unit obtains a change from the reference parameter for one of the plurality of parameters, and the parameter extracting unit extracts only parameter sets, from among the plurality of parameter sets stored in the setting storage unit, that do not involve the obtained change in the parameter. By developing, using the extracted parameter sets, the image data acquired by the imaging unit, it is possible to give the user ideas of visual effects in images obtained when parameters are changed, thus expanding the range of expression.

Another aspect of the present invention is an image processing method including: a change obtaining step of obtaining a change, made by a user, from a reference parameter for one of a plurality of parameters; a parameter extracting step of extracting, in the case where the change in the parameter has been obtained in the change obtaining step, parameter sets remaining after excluding the parameter sets involving the change in the changed parameter from among a plurality of stored parameter sets each constituted of the plurality of parameters including photographing conditions and developing conditions; and a developing step of developing image data using the parameter sets extracted in the parameter extracting step.

Another aspect of the present invention is an image processing program for causing a computer to execute: change obtainment processing for obtaining a change, made by a user, from a reference parameter for one of a plurality of parameters; parameter extracting processing for extracting, in the case where the change in the parameter has been obtained through the change obtainment processing, parameter sets remaining after excluding the parameter sets involving the change in the changed parameter from among a plurality of stored parameter sets each constituted of the plurality of parameters including photographing conditions and developing conditions; and development processing for developing image data using the parameter sets extracted through the parameter extracting processing.

Another aspect of the present invention is an image acquisition system including: an imaging device that acquires image data; and an image processing device capable of carrying out communications with the imaging device, wherein the imaging device includes an image storage unit that stores the acquired image data and a developing unit that develops the image data stored in the image storage unit, wherein the image processing device includes a setting storage unit that stores a plurality of parameter sets each constituted of a plurality of parameters including photographing conditions and developing conditions, a change obtaining unit that obtains a change from a reference parameter for one of the parameters relating to the photographing conditions, the change being made by a user at the time of acquisition of the image data by the imaging device, and a parameter extracting unit that extracts the parameter sets remaining after excluding the parameter sets involving the change in the changed parameter in the case where the change obtaining unit has obtained the change in the parameter, and wherein the developing unit develops, using the parameter sets extracted by the parameter extracting unit, the image data acquired by the imaging device.

According to this aspect, if the user changes one of the parameters relating to photographing conditions from the reference parameter in performing photography to acquire image data by using the imaging device, the photographed information is sent to the image processing device by way of communications. Then, at the image processing device, the change obtaining unit obtains the parameter change made at the time of acquisition of the image data, and the parameter extracting unit extracts only the parameter sets that do not involve the obtained change in the parameter from among the plurality of parameter sets stored in the setting storage unit. Then, the image data acquired by the imaging device is developed by the developing unit included in the imaging device, using the extracted parameter sets.

That is, it is possible to give the user ideas of visual effects in images obtained when parameters are changed, thus expanding the range of expression. Furthermore, because there is no need to send large-size image data acquired by the imaging device to the image processing device by way of communications, it is possible to reduce the processing time.

Another aspect of the present invention is an image processing device capable of carrying out communications with an imaging device including an imaging unit that acquires image data, an image storage unit that stores the image data acquired by the imaging unit, and a developing unit that develops the image data stored in the image storage unit. The image processing device includes: a setting storage unit that stores a plurality of parameter sets each constituted of a plurality of parameters including photographing conditions and developing conditions; a change obtaining unit that obtains a change from a reference parameter for one of the parameters relating to the photographing conditions, the change being made by a user at the time of acquisition of the image data by the imaging device; and a parameter extracting unit that extracts the parameter sets remaining after excluding the parameter sets involving the change in the changed parameter in the case where the change obtaining unit has obtained the change in the parameter. The parameter sets extracted by the parameter extracting unit are used for development of the image data acquired by the imaging unit.

Another aspect of the present invention is an image acquisition system including: an imaging device that acquires image data; a setting storage device that stores a plurality of parameter sets each constituted of a plurality of parameters including photographing conditions and developing conditions; and an image processing device capable of carrying out communications with the imaging device and the setting storage device, wherein the imaging device includes an image storage unit that stores the acquired image data and a developing unit that develops the image data stored in the image storage unit, wherein the image processing device includes a change obtaining unit that obtains a change from a reference parameter for one of the parameters relating to the photographing conditions, the change being made by a user at the time of acquisition of the image data by the imaging device; and a parameter extracting unit that extracts the parameter sets remaining after excluding the parameter sets involving the change in the changed parameter in the case where the change obtaining unit has obtained the change in the parameter, wherein the developing unit develops, using the parameter sets extracted by the parameter extracting unit, the image data acquired by the imaging device.

According to this aspect, if the user changes one of the parameters relating to photographing conditions from the reference parameter in performing photography to acquire image data by using the imaging device, the photographed information is sent to the image processing device by way of communications. Then, the change obtaining unit of the image processing device obtains the parameter change made at the time of acquisition of the image data. Furthermore, the image processing device reads the plurality of parameter sets stored in the setting storage device by way of communications and extracts only the parameter sets that do not involve the obtained change in the parameter. Then, the image data acquired by the imaging device is developed by the developing unit included in the imaging device, using the extracted parameter sets.

Another aspect of the present invention is an image processing device capable of carrying out communications with: an imaging device including an imaging unit that acquires image data, an image storage unit that stores the image data acquired by the imaging unit, and a developing unit that develops the image data stored in the image storage unit; and a setting storage device that stores a plurality of parameter sets each constituted of a plurality of parameters including photographing conditions and developing conditions, the image processing device including: a change obtaining unit that obtains a change from a reference parameter for one of the parameters relating to the photographing conditions, the change being made by a user at the time of acquisition of the image data by the imaging device; and a parameter extracting unit that extracts the parameter sets remaining after excluding the parameter sets involving the change in the changed parameter in the case where the change obtaining unit has obtained the change in the parameter, wherein the parameter sets extracted by the parameter extracting unit are used for development of the image data acquired by the imaging unit.

Another aspect of the present invention is an image acquisition system wherein an imaging device that acquires image data, a developing device that develops the image data, and an image processing device are capable of carrying out communications with one another, wherein the imaging device includes an imaging unit that acquires the image data, and an image storage unit that stores the acquired image data, wherein the image processing device includes a setting storage unit that stores a plurality of parameter sets each constituted of a plurality of parameters including photographing conditions and developing conditions, a change obtaining unit that obtains a change from a reference parameter for one of the parameters relating to the photographing conditions, the change being made by a user at the time of acquisition of the image data by the imaging device, and a parameter extracting unit that extracts the parameter sets remaining after excluding the parameter sets involving the change in the changed parameter in the case where the change obtaining unit has obtained the change in the parameter, and wherein the developing device develops, using the parameter sets extracted by the parameter extracting unit, the image data acquired by the imaging unit.

According to this aspect, if the user changes one of the parameters relating to photographing conditions from the reference parameter in performing photography to acquire image data by using the imaging device, the photographed information is sent to the image processing device by way of communications. Then, the change obtaining unit of the image processing device obtains the parameter change made at the time of acquisition of the image data. Furthermore, the image processing device reads the plurality of parameter sets stored in the setting storage unit and extracts only the parameter sets that do not involve the obtained change in the parameter. Then, the image data acquired by the imaging device is developed by the developing unit, using the extracted parameter sets.

Another aspect of the present invention is an image processing device capable of carrying out communications with an imaging device that acquires image data and a developing device that develops the image data, the imaging device including an imaging unit that acquires image data and an image storage unit that stores the acquired image data, the image processing device including: a setting storage unit that stores a plurality of parameter sets each constituted of a plurality of parameters including photographing conditions and developing conditions; a change obtaining unit that obtains a change from a reference parameter for one of the parameters relating to the photographing conditions, the change being made by a user at the time of acquisition of the image data by the imaging device; and a parameter extracting unit that extracts the parameter sets remaining after excluding the parameter sets involving the change in the changed parameter in the case where the change obtaining unit has obtained the change in the parameter, wherein the parameter sets extracted by the parameter extracting unit are used for development of the image data acquired by the imaging device.

### REFERENCE SIGNS LIST

1 Image acquisition device

2 Imaging unit

4 Setting storage unit

5 Change obtaining unit

6 Setting selecting unit

7 Developing unit

11 Type recognition unit

12 Parameter extracting unit

20 Imaging device

30 Image processing device

40 Setting storage device

60 Developing device

100 Image acquisition system

S1 Change obtaining step

S2 Parameter extracting step

S3 Setting selecting step

S4 Developing step

1. An image acquisition device comprising:
a computer configured to:
acquire image data;
store a plurality of parameter sets each constituted of a plurality of parameters including photographing conditions and developing conditions;
obtain a change from a reference parameter for one of the parameters relating to the photographing conditions, the change being made by a user at the time of acquisition of the image data;
extract the parameter sets remaining after excluding the parameter sets involving the change in the changed parameter in a case where the change in the parameter has been obtained; and
develop, using the extracted parameter sets, the acquired image data.

2. The image acquisition device according to claim 1, wherein the computer is configured to present the extracted parameter sets and allow the user to select one therefrom.

3. The image acquisition device according to claim 1, wherein the computer is configured to present images showing the effects obtained when the image data is developed using the extracted parameter sets and allow the user to select one therefrom.

4. The image acquisition device according to claim 1, wherein
the stored parameters have a hierarchical structure, and
in a case where a change in one of the parameters has been obtained, the computer is configured to exclude parameter sets involving any change in the parameters included in a higher level than the parameter for which the change has been obtained.

5. The image acquisition device according to claim 1, wherein the computer is configured to:
recognize a type of an object or a type of a scene in the image data,
store the parameter sets as classified on the basis of the type of the object or the type of the scene, and
extract parameter sets to be presented from parameter sets belonging to the class matching the recognized type of the object or the recognized type of the scene.

6. An image processing device comprising:
a computer configured to:
store a plurality of parameter sets each constituted of a plurality of parameters including photographing conditions and developing conditions;
obtain a change, made by a user, from a reference parameter for one of the parameters;
extract the parameter sets remaining after excluding the parameter sets involving the change in the changed parameter in a case where the change in the parameter has been obtained; and
develop image data using the extracted parameter sets.

7. An image processing method comprising:
obtaining a change, made by a user, from a reference parameter for one of a plurality of parameters;
extracting, in a case where the change in the parameter has been obtained, parameter sets remaining after excluding the parameter sets involving the change in the changed parameter from among a plurality of stored parameter sets each constituted of the plurality of parameters including photographing conditions and developing conditions; and
developing image data using the extracted parameter sets.

8. A non-transitory computer-readable medium having an image processing program stored therein, the image processing program causing a computer to execute functions of:
obtaining a change, made by a user, from a reference parameter for one of a plurality of parameters;
extracting, in a case where the change in the parameter has been obtained, parameter sets remaining after excluding the parameter sets involving the change in the changed parameter from among a plurality of stored parameter sets each constituted of the plurality of parameters including photographing conditions and developing conditions; and
developing image data using the extracted parameter sets.

9. An image acquisition system comprising:
an imaging device that acquires image data, that stores the acquired image data, and that develops the stored image data; and
an image processing device configured to carry out communications with the imaging device,
wherein the image processing device includes:
a computer configured to:
store a plurality of parameter sets each constituted of a plurality of parameters including photographing conditions and developing conditions;
obtain a change from a reference parameter for one of the parameters relating to the photographing conditions, the change being made by a user at the time of acquisition of the image data by the imaging device; and
extract the parameter sets remaining after excluding the parameter sets involving the change in the changed parameter in a case where the change in the parameter has been obtained, and
wherein the imaging device develops the acquired image data using the parameter sets extracted by the image processing device.

10. An image acquisition system comprising:
an imaging device that acquires image data, that stores the acquired image data, and that develops the stored image data;
a setting storage device that stores a plurality of parameter sets each constituted of a plurality of parameters including photographing conditions and developing conditions; and
an image processing device configured to carry out communications with the imaging device and the setting storage device,
wherein the image processing device includes:
a computer configured to:
obtain a change from a reference parameter for one of the parameters relating to the photographing conditions, the change being made by a user at the time of acquisition of the image data by the imaging device; and
extract the parameter sets remaining after excluding the parameter sets involving the change in the changed parameter in a case where the change in the parameter has been obtained, and
wherein the imaging device develops the acquired image data using the parameter sets extracted by the image processing device.

11. An image acquisition system,
wherein an imaging device that acquires image data and that stores the acquired image data, a developing device that develops the image data, and an image processing device are configured to carry out communications with one another,
wherein the image processing device includes:
a computer configured to:
store a plurality of parameter sets each constituted of a plurality of parameters including photographing conditions and developing conditions;
obtain a change from a reference parameter for one of the parameters relating to the photographing conditions, the change being made by a user at the time of acquisition of the image data by the imaging device; and
extract the parameter sets remaining after excluding the parameter sets involving the change in the changed parameter in a case where the change in the parameter has been obtained, and
wherein the developing device develops, using the parameter sets extracted by the image processing device, the image data acquired by the imaging device.
